(19) United States
(12) Patent Application Publication
(10) Pub. No.: US 2014/0082912 A1
(43) Pub. Date: Mar. 27, 2014

(54) TURBOMACHINE INCLUDING A CRACK ARRESTMENT SYSTEM AND METHOD

(71) Applicant: GENERAL ELECTRIC COMPANY, Schenectady, NY (US)

(72) Inventors: Gajendra Narayanachar, Bangalore (IN); Babu Santhanagopalakrishnan, Bangalore (IN); Sasi Kumar Tippabhotla, Chennai (IN); Jayakrishna Velampati, Bangalore (IN)

(73) Assignee: GENERAL ELECTRIC COMPANY, Schenectady, NY (US)

(21) Appl. No.: 13/628,752

(22) Filed: Sep. 27, 2012

(51) Int. Cl. F16B 11/00; B23P 6/00

(52) U.S. Cl. 29/402.09; 403/30

(57) ABSTRACT

A turbomachine includes a member formed from a material having a first coefficient of thermal expansion. The member includes a crack. A crack arrestment system is provided in the member. The crack arrestment system includes at least one crack arresting element provided at the crack. The at least one crack arresting element has a second coefficient of thermal expansion that is distinct from the first coefficient of thermal expansion. The at least one crack arresting element is configured and disposed to exert a compressive force on the member at the crack to substantially arrest crack propagation.

### BACKGROUND OF THE INVENTION

The subject matter disclosed herein relates to the art of turbomachines and, more particularly, to a turbomachine having a crack arrestment system and method of arresting cracks formed in a turbomachine member.

Many turbomachines include a compressor portion linked to a turbine portion through a common compressor/turbine shaft or rotor and a combustor assembly. The compressor portion guides compressed air flow through a number of sequential stages toward the combustor assembly. In the combustor assembly, the compressed air flow mixes with a fuel to form a combustible mixture. The combustible mixture is combusted in the combustor assembly to form hot gases. The hot gases are guided to the turbine portion through a transition piece. The hot gases expand through the turbine portion rotating turbine blades to create work that is output, for example, to power a generator, a pump, or to provide power to a vehicle. In addition to providing compressed air for combustion, a portion of the compressed airflow is passed through the turbine portion for cooling purposes. Generally the compressor portion includes a compressor casing and the turbine portion includes a turbine casing. During normal use, cracks may develop in one, the other, or both of the compressor casing and the turbine casing. Cracks may also develop in other portions of the turbomachine.

### BRIEF DESCRIPTION OF THE INVENTION

According to one aspect of the exemplary embodiment, a turbomachine includes a member formed from a material having a first coefficient of thermal expansion. The member includes a crack. A crack arrestment system is provided in the member. The crack arrestment system includes at least one crack arresting element provided at the crack. The at least one crack arresting element has a second coefficient of thermal expansion that is distinct from the first coefficient of thermal expansion. The at least one crack arresting element is configured and disposed to exert a compressive force on the member at the crack to substantially arrest crack propagation.

According to another aspect of the exemplary embodiment, a method of arresting cracks formed in a turbomachine member includes securing at least one crack arresting element to the turbomachine member adjacent a crack, and applying a compressive force to the turbomachine member adjacent to the crack through the at least one crack arresting element to substantially arrest crack propagation.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial perspective view of a portion of a turbomachine including a crack arrestment system in accordance with an exemplary embodiment;

FIG. 2 is a partial plan view of a strut portion of the turbomachine of FIG. 1 including a crack supported by a crack arresting element of the crack arrestment system of the exemplary embodiment; and

FIG. 3 is a perspective view of the crack arresting element of FIG. 2.

The detailed description explains embodiments of the invention, together with advantages and features, by way of example with reference to the drawings.

### DETAILED DESCRIPTION OF THE INVENTION

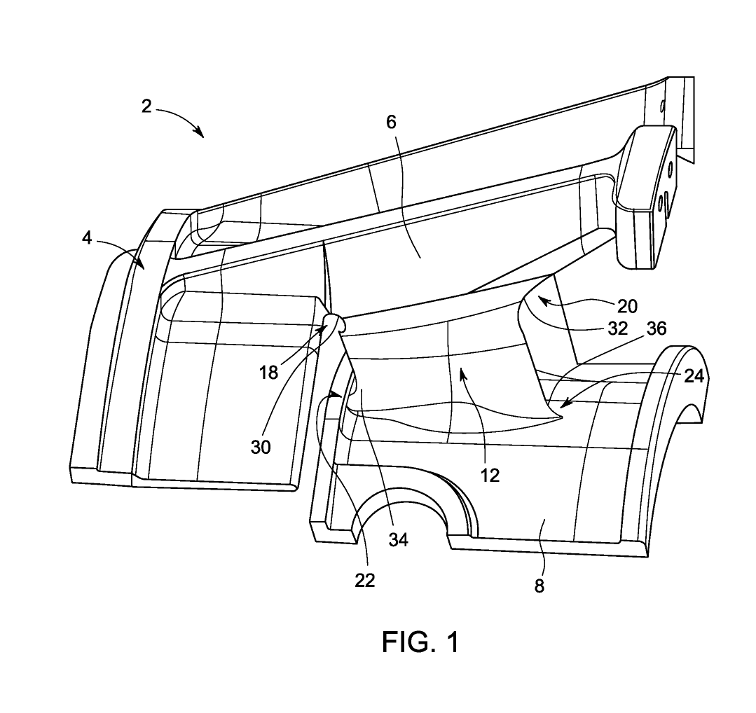

A turbomachine in accordance with an exemplary embodiment is indicated generally at 2 in FIG. 1. Turbomachine 2 includes a casing assembly 4 that forms part of a turbine portion (not separately labeled). Casing assembly 4 includes a first casing member 6 operatively connected to a second casing member 8 through a strut member 12. Strut member 12 is joined to first casing member 6 through a first interface zone 18 and a second interface zone 20. Strut member 12 is joined to second casing member 8 through a third interface zone 22 and a fourth interface zone 24. First interface zone 18 includes a first radius portion 30. Second interface zone 20 includes a second radius portion 32. Third interface zone 22 includes a third radius portion 34, and fourth interface zone 24 includes a fourth radius portion 36. Casing assembly 4 is formed from a first material having a first coefficient of thermal expansion. Of course, it should be understood that the type of material used to form casing assembly 4 may vary.

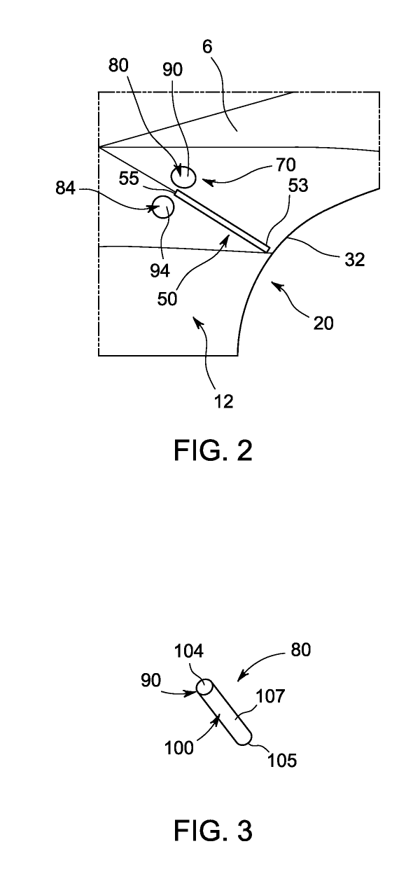

During operation, casing assembly 4 is subjected to thermal load cycles. Occasionally, the thermal load cycles may lead to development of fissures or cracks. As best shown in FIG. 2, a crack 50 is shown at second interface zone 20. Crack 50 includes a first end 53 at second radius portion 32 that extends across a portion of strut member 12 to a second end 55. Continued operation of turbomachine 2 may lead to crack propagation, or a shifting of second end 55, along strut member 12. Accordingly, it is desirable to arrest crack propagation to avoid costly down time for extensive repair and/or replacement of casing assembly 4. In accordance with an exemplary embodiment, casing assembly 4 is provided with a crack arrestment system 70 that is configured to substantially limit crack propagation on strut member 12.

In accordance with an exemplary embodiment, crack arrestment system 70 includes a first crack arresting element 80 and a second crack arresting element 84. First crack arresting element 80 takes the form of a first plug 90 that is embedded in strut member 12 alongside crack 50. Second crack arresting element 84 takes the form of a second plug 94 embedded in strut member 12 on an opposing side of crack 50. First and second plugs 90 and 94 are arranged adjacent to second end 55 of crack 50. As will be discussed more fully below, first and second plugs 90 and 94 selectively exert a compressive force on crack 50 to prevent or at least substantially limit movement of second end 55 over strut member 12.

As first plug 90 and second plug 94 are shown as being generally similar, a detailed description will follow with reference to FIG. 3 and first plug 90 with an understanding that, in the exemplary embodiment shown, second plug 94 includes corresponding structure. First plug 90 includes a body 100 having a first end portion 104 that extends to a second end portion 105 through an intermediate portion 107. In the exemplary embodiment shown, body 100 includes a generally circular cross-section. However, it should be understood that the particular geometry of body 100 may vary.

First plug 90 is formed from a material having a second coefficient of thermal expansion that is distinct from the first coefficient of thermal expansion. More specifically, first plug 90 is formed from a second or “high alpha” material having a coefficient of thermal expansion that is greater than the first coefficient of thermal expansion of the first material. With this arrangement, first and second plugs 90 and 94 are installed in openings (not separately labeled) formed in strut member 12 adjacent to crack 50. Once installed, operation of turbomachine 2 causes strut member 12 to be heated. First and second plugs 90 and 94 are also heated and begin to expand at a rate that is faster than a rate of expansion of strut member 12. Expansion of first and second plugs 90 and 94 exerts a compressive force on crack 50 that substantially limits crack propagation when strut member 12 is exposed to thermal load cycles during the turbomachine operation.

In accordance with another aspect of the exemplary embodiment, first and second plugs 90 and 94 are formed from a shaped memory alloy configured to expand at a rate greater than the first material so as to exert a compressive force on crack 50. In accordance with still another aspect of the exemplary embodiment, the shaped memory alloy takes the form of a nickel/titanium alloy or Nitinol. When using shaped memory alloys, openings (not separately labeled) are formed in strut member 12 adjacent crack 50. First and second plugs 90 and 94 are adjusted from a first size that is greater than size of the openings to a second size that allows installation into the openings. When heated, plugs 90 and 94 attempt to return to the first size resulting in a compressive force being applied to crack 50.

At this point it should be understood that the exemplary embodiments provide a system for arresting cracks in a turbomachine. The crack arrestment system employs one or more plugs that are installed alongside a crack formed in a base material. The plugs are formed from a material that is designed to grow at a rate greater than the base material when exposed to heat. In this manner, the plugs may exert a compressive force on the crack to prevent or at least substantially arrest crack propagation. It should also be understood, that while shown and described as having a generally cylindrical cross-section, the geometry of the plugs may vary. Also, while shown as using two plugs to create the compressive force, the number of plugs may vary. In certain instances, a single plug may be all that is needed, in other instances, more than two plugs may be desirable. Finally, while shown and described as being a shaped memory alloy, the plugs may be formed from a wide variety of materials.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A turbomachine comprising:
a member formed from a material having a first coefficient of thermal expansion, the member including a crack; and
a crack arrestment system provided in the member, the crack arrestment system including at least one crack arresting element provided at the crack, the at least one crack arresting element having a second coefficient of thermal expansion that is distinct from the first coefficient of thermal expansion, the at least one crack arresting element being configured and disposed to exert a compressive force on the member at the crack to substantially arrest crack propagation.

2. The turbomachine according to claim 1, wherein the at least one crack arresting element includes a first crack arresting element positioned on one side of the crack and a second crack arresting element positioned on a second, opposing side of the crack.

3. The turbomachine according to claim 2, wherein the first crack arresting element comprises a first plug inserted into the member and the second crack arresting element comprises a second plug inserted into the member.

4. The turbomachine according to claim 3, wherein each of the first and second plugs includes a generally circular cross-section.

5. The turbomachine according to claim 1, wherein the at least one crack arresting element is formed from a shaped memory alloy.

6. The turbomachine according to claim 5, wherein the shaped memory alloy includes nitinol.

7. The turbomachine according to claim 1, wherein the second coefficient of thermal expansion is greater than the first coefficient of thermal expansion.

8. The turbomachine according to claim 1, wherein the member comprises a portion of a turbomachine assembly.

9. The turbomachine according to claim 8, wherein the portion of the turbomachine assembly comprises a strut member.

10. A method of arresting cracks formed in a turbomachine member, the method comprising:
securing at least one crack arresting element to the turbomachine member adjacent a crack; and
applying a compressive force to the turbomachine member adjacent to the crack through the at least one crack arresting element to substantially arrest crack propagation.

11. The method of claim 10, wherein securing the at least one crack arresting element to the turbomachine member includes installing a first plug into the turbomachine member on one side of the crack and installing a second plug into the turbomachine member on a second opposing side.

12. The method of claim 11, wherein installing the first and second plugs in the turbomachine member includes positioning the first and second plugs in the turbomachine member adjacent a leading edge of the crack.

13. The method of claim 12, wherein positioning the first and second plugs in the turbomachine member adjacent the leading edge of the crack includes installing the first and second plugs in the turbomachine member beyond the leading edge of the crack.

14. The method of claim 11, wherein installing the first and second plugs in the turbomachine member includes installing the first and second plugs into a portion of a turbomachine assembly.

15. The method of claim 14, wherein installing the first and second plugs into the portion of a turbomachine assembly includes installing the first and second plugs into a strut member.

16. The method of claim 11, wherein applying the compressive force to the turbomachine member comprises thermally expanding the first and second plugs.

17. The method of claim 16, wherein thermally expanding the first and second plugs includes heating first and second plugs formed from a shaped memory alloy.

18. The method of claim 17, wherein heating the first and second plugs formed from a shaped memory alloy includes heating first and second plugs formed from nitinol.
